(19) United States
(12) Patent Application Publication
(10) Pub. No.: US 2016/0366931 A1
(43) Pub. Date: Dec. 22, 2016

(54) Hookah Smoking Device

(71) Applicant: NIGNBO HOOKAH ARTWARE CO., LTD., Ningbo (CN)

(72) Inventor: ENFENG ZHANG, Ningbo (CN)

(21) Appl. No.: 15/249,461

(22) Filed: Aug. 28, 2016

(30) Foreign Application Priority Data
May 30, 2015 (CN) 201610373507.0
Mar. 31, 2016 (CN) 201620261090.4

(51) Int. Cl. A24F 1/30; F16L 37/00

(52) U.S. Cl. CPC A24F 1/30; F16L 37/004

(57) ABSTRACT

A hookah smoking device includes a loading unit, a filtering unit, and a connecting mechanism. The connecting mechanism includes at least one first connecting unit provided at the loading unit and at least one second connecting unit provided at the filtering unit, wherein the first connecting unit and the second connecting unit are magnetically coupled with each other to detachably couple the loading unit at the filtering unit. The hookah smoking device further includes a smoking inhaler adapted to be detachably coupled at the loading unit via the connecting mechanism.

### CROSS REFERENCE OF RELATED APPLICATION

This is a non-provisional application that claims priority to a first Chinese application number CN201620261090.4, filing date Mar. 31, 2016 and a second Chinese application number CN201610373507.0, filing date May 30, 2016, the entire contents of each of which are expressly incorporated herein by reference.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

Field of Invention

The present invention relates to a tobacco smoking device, and more particular to a hookah smoking device.

Description of Related Arts

Unlike cigarette that can be directly smoked, hookah is an instrument for smoking tobacco or its substitute by filtering the smoke by liquid, such as water, before inhalation. Through the hookah, several harmful ingredients in the smoke can be filtered by liquid, before inhalation to reduce the health risk for the human body. Having this benefit, hookah has been commonly pursued and welcomed in recent year. Unlike the way of smoking traditional cigarette, smoking hookah requires special equipment. Currently, hookah smoking is conducted with hookah pot.

Normally, a hookah pot includes a pot, a tobacco container, and a smoking inhaler. The tobacco container is detachably mounted on the pot. The smoking inhaler, which is arranged on the tobacco container, has a tobacco placing slot and a channel having an upper portion connecting to the tobacco placing slot. The lower portion of the channel extends to the inside of the pot. To use the hookah pot, the tobacco container is first disassembled from the pot, so as to fill with appropriate amount of liquid, such as water, into the pot. Then the tobacco container is mounted back to the pot until the lower portion of the channel is immersed in the liquid within the pot. The tobacco or its substitute will be placed in the tobacco placing slot. The smoker may smoke with the smoking inhaler. Smoke generated by tobacco or its substitute will be sucked from the upper portion of the channel through the lower portion of the channel to enter the liquid in the pot, such that the smoke will then be filtered by the liquid. Afterward, the filtered smoke can be smoked by the smoker through the smoking inhaler. It is worth mentioning that the liquid in the pot must be frequently replaced. For instance, every smoke through the hookah pot requires a replacement of the liquid in the pot. As a result, the tobacco container and the pot will be frequently assembled and disassembled. In other words, the assembling and disassembling of the tobacco container and the pot should be easy and convenient. Besides, because the pot of the hookah pot is usually big and heavy, smoker (or service personnel) often moves the hookah pot by grasping the tobacco container. Therefore, the connection between the tobacco container and the pot of the hookah pot must be secured and reliable.

Currently, there is a hookah pot which connects the tobacco container and the pot thereof with threaded structure. That is, the connecting position of the tobacco container and the connecting position of the pot respectively have inner and outer threaded structures corresponding to each other. Although this threaded structure ensures the reliability of the connection of the tobacco container and the pot, the assembling and disassembling operations of the tobacco container and the pot require turning at least one of the tobacco container and the pot, which is very inconvenient to the hookah pot that demands frequent assembling and disassembling of the tobacco container and the pot. Moreover, such conventional device also has to disassemble the smoking inhaler when mounting the tobacco container back to the pot. Otherwise the smoking inhaler can be damaged or twisted when the tobacco container is rotated on the pot.

Another current hookah pot utilizes a locking arm to connect the tobacco container and the pot. For instance, one end of the locking arm is arranged at the connecting position of the tobacco container and the other end of the locking arm locks on another end of the pot, so as to couple the tobacco container with the pot. Although the locking arm ensures the reliability of the coupling between the tobacco container and the pot and to allow quick assembling and disassembling of the tobacco container and the pot, the structural configuration of the locking arm not only makes the structure of the hookah pot more complicated, but also affect the aesthetic design of the hookah pot. It is because the locking arm is a mechanical part directly exposed outside, such that the locking arm will affect the aesthetic appearance of the hookah pot.

### SUMMARY OF THE PRESENT INVENTION

An object of the present invention is to provide a hookah smoking device, wherein the hookah smoking device provides a connecting mechanism that enables quick assembling and separation for the filtering unit and the loading unit of the hookah smoking device.

An object of the present invention is to provide a hookah smoking device, wherein the connecting mechanism enables quick assembling and separation for the smoking inhaler and the loading unit of the hookah smoking device.

An object of the present invention is to provide a hookah smoking device, wherein the connecting mechanism can allow the loading unit to be directly mounted on the filtering unit.

An object of the present invention is to provide a hookah smoking device, wherein the connecting mechanism can allow the smoking inhaler to be directly mounted on the loading unit.

An object of the present invention is to provide a hookah smoking device, wherein the connecting mechanism can ensure that the assembled loading unit and filtering unit will not automatically separate.

An object of the present invention is to provide a hookah smoking device, wherein the connecting mechanism can have a tendency and displacement to make the loading unit automatically mount on the filtering unit when the loading unit is moved to a proper position relative to the filtering unit, so as to make the operation of the hookah smoking device more convenient.

An object of the present invention is to provide a hookah smoking device, wherein the connecting mechanism provide a magnetically attracted first connecting unit and second connecting unit, wherein the first connecting unit is arranged at the loading unit, while the second connecting unit is arranged at the filtering unit, wherein the first connecting unit and the second connecting unit magnetically attach to each other to make the loading unit and the filtering unit be assembled together.

An object of the present invention is to provide a hookah smoking device, wherein the connecting mechanism provides an aligning body that when the hookah smoking device is in use, the aligning body is adapted to prevent the smoker from misoperating the connecting mechanism for preventing the loading unit from automatically separated from the filtering unit.

An object of the present invention is to provide a hookah smoking device, wherein when the first connecting unit and the second connecting unit attach to each other to assemble the loading unit and the filtering unit, the aligning elements are able to prevent horizontal motions between the loading unit and the filtering unit, so as to prevent the loading unit from automatically separating from the filtering unit.

An object of the present invention is to provide a hookah smoking device, wherein at least one of the first connecting unit and the second connecting unit is actionably arranged for the operating personnel to easily operate the connecting mechanism to separate the loading unit from the filtering unit.

An object of the present invention is to provide a hookah smoking device, wherein the first connecting unit provides a magnetic first connecting element, while the second connecting unit provides a magnetic second connecting element. The first connecting element and the second connecting element can interact to generate attractive forces therebetween, so as to assemble the loading unit with the filtering unit, and to conceal the first connecting element and the second connecting element.

The hookah smoking device that is able to achieve the above and other objects and advantages according to the present invention, comprising:

a loading unit;

a filtering unit; and

a connecting mechanism, wherein said connecting mechanism comprises a magnetically attracted first connecting unit and second connecting unit, wherein said first connecting unit is arranged at said loading unit, while said second connecting unit is arranged at said filtering unit, wherein said first connecting unit and said second connecting unit intercouple by mutually attaching to each other, so that said loading unit is detachably mounted on said filtering unit.

According to a preferred embodiment of the present invention, the hookah smoking device further comprises at least a smoking inhaler, wherein each smoking inhaler is spacedly arranged on the loading unit.

According to a preferred embodiment of the present invention, each smoking inhaler is detachably mounted on the loading unit.

According to a preferred embodiment of the present invention, the first connecting unit is arranged at the loading unit, while the second connecting unit is arranged at the smoking inhaler, wherein the first connecting unit and the second connecting unit intercouple by mutually attaching to each other, so that the smoking inhaler is detachably mounted on the filtering unit.

According to a preferred embodiment of the present invention, the hookah smoking device further comprises a ventilating unit, arranged on the loading unit.

According to a preferred embodiment of the present invention, at least one of the first connecting unit and the second connecting unit is magnetic body or contains magnetic body.

According to a preferred embodiment of the present invention, the loading unit comprises a loading body, a conveying channel, and an assembling body, wherein the assembling body is arranged on the conveying channel and the loading body is arranged on the upper portion of the conveying channel, wherein the first connecting unit is arranged at the assembling body or integrally formed with the assembling body, wherein the filtering unit comprises a filter chamber and an opening communicated with the filter chamber, wherein the second connecting unit is arranged at the opening of the filtering unit or integrally formed with the filtering unit, wherein the lower portion of the conveying channel is inserted and retained in the filter chamber through the opening.

According to a preferred embodiment of the present invention, the first connecting unit comprises a first connecting body and a magnetic first connecting element, wherein the first connecting body is arranged on the assembling body or integrally formed with the assembling body, while the first connecting element is arranged on the first connecting body, wherein the second connecting unit comprises a second connecting body and a magnetic second connecting element, wherein the second connecting body is arranged on the opening of the filtering unit or integrally formed with the filtering unit, while the second connecting element is arranged on the second connecting body, wherein the first connecting element and the second connecting element intercouple by attaching to each other, such that the contact surface of the first connecting body and the contact surface of the second connecting body attach on each other.

According to a preferred embodiment of the present invention, the first connecting body and the second connecting body have oxidation resistance layer thereon.

According to a preferred embodiment of the present invention, the first connecting element is protruded from the first connecting body, wherein the second connecting body comprises an aligning groove and the second connecting element is located at the aligning groove, wherein the first connecting element is attracted by the second connecting element, so as to cause the first connecting element be aligned at the aligning groove.

According to a preferred embodiment of the present invention, the first connecting body comprises an aligning groove, wherein the first connecting element is located at the aligning groove, wherein the second connecting element is protruded from the second connecting body, wherein the second connecting element is attracted by the first connecting element, so as to cause the second connecting element be aligned at the aligning groove.

According to a preferred embodiment of the present invention, the connecting mechanism comprises an aligning body, integrally extended from the first connecting body and allowed to be kept inside of the second connecting body.

According to a preferred embodiment of the present invention, the connecting mechanism comprises an aligning body, wherein the first connecting unit comprises a first connecting body and a magnetic first connecting element, wherein the first connecting body is arranged on the assembling body or integrally formed with the assembling body, wherein the aligning body is integrally extended from the first connecting body, and the first connecting element is arranged at the aligning body, wherein the second connecting unit comprises a second connecting body and a magnetic second connecting element, wherein the second connecting body is arranged on the opening of the filtering unit or integrally formed with the filtering unit, wherein the second connecting element is arranged on the second connecting element, wherein the aligning body is allowed to be kept inside of the second connecting body, so as to allow the first connecting element and the second connecting element to attach to each other.

According to a preferred embodiment of the present invention, the connecting mechanism comprises an aligning body, wherein the first connecting unit comprises a magnetic first connecting element, wherein the aligning body is integrally extended from the assembling body, and the first connecting element is arranged at the aligning body, wherein the second connecting unit comprises a second connecting body and a magnetic second connecting element, wherein the second connecting body is arranged on the opening of the filtering unit or integrally formed with the filtering unit, wherein the second connecting element is arranged on the second connecting element, wherein the aligning body is allowed to be kept inside of the second connecting body, so as to allow the first connecting element and the second connecting element to attach to each other.

According to a preferred embodiment of the present invention, the first connecting unit comprises a first connecting body and a magnetic first connecting element, wherein the first connecting body is arranged on the assembling body or integrally formed with the assembling body, while the first connecting element is arranged on the first connecting body, wherein the second connecting element comprises a second connecting body and a magnetic second connecting element, wherein the second connecting body is actionably arranged on the filtering unit, while the second connecting element is arranged on the second connecting body, wherein the first connecting element and the second connecting element intercouple by attaching to each other, such that the contact surface of the first connecting body and the contact surface of the second connecting body attach on each other.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a three-dimensional perspective view of a hookah smoking device according to a first preferred embodiment of the present invention.

FIG. 2 is a side perspective view of the hookah smoking device according to the above preferred embodiment of the present invention.

FIG. 3 is an exploded view of the hookah smoking device according to the above preferred embodiment of the present invention.

FIG. 4 is an internal structural view of the centrally split hookah smoking device according to the above preferred embodiment of the present invention.

FIG. 5 is a three-dimensional perspective view of a connecting mechanism of the hookah smoking device according to the above preferred embodiment of the present invention.

FIG. 6 is a side perspective view of the connecting mechanism of the hookah smoking device according to the above preferred embodiment of the present invention.

FIG. 7 is an exploded view of the connecting mechanism of the hookah smoking device according to the above preferred embodiment of the present invention.

FIG. 8 is an internal structural view of the centrally split connecting mechanism of the hookah smoking device according to the above preferred embodiment of the present invention.

FIG. 9 is an internal structural view of the centrally split hookah smoking device according to an alternative of the above preferred embodiment of the present invention.

FIG. 10 is an internal structural view of the centrally split hookah smoking device according to another alternative of the above preferred embodiment of the present invention.

FIG. 11 is an internal structural view of the centrally split hookah smoking device according to another alternative of the above preferred embodiment of the present invention.

FIG. 12 is a three-dimensional perspective view of a hookah smoking device according to a second preferred embodiment of the present invention.

FIG. 13 is an internal structural view of the centrally split hookah smoking device according to the above preferred embodiment of the present invention.

FIG. 14 is a sectional view of an operating state of the hookah smoking device according to the above preferred embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

The following description is to disclose the present invention so that those skilled in the art can implement the present invention. The preferred embodiments in the following description are only to give examples that those skilled in the art can come up with other obvious alternatives. The basic principles of the present invention defined in the following description can also apply to other embodiments, alternatives, improvements, equivalents, and other technical solutions that do not leave the spirit and scope of the present invention.

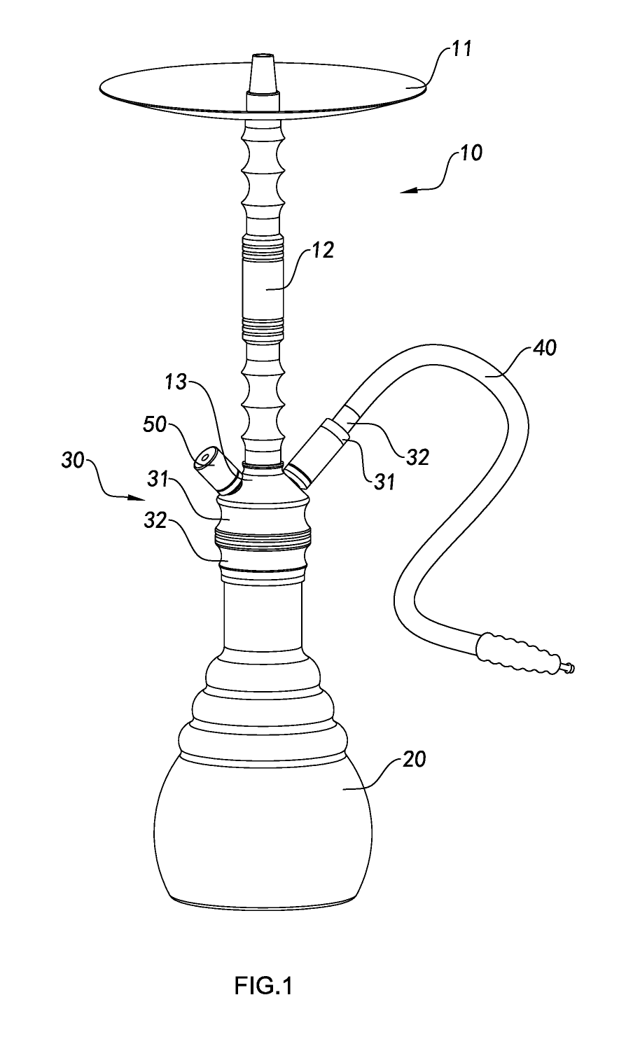

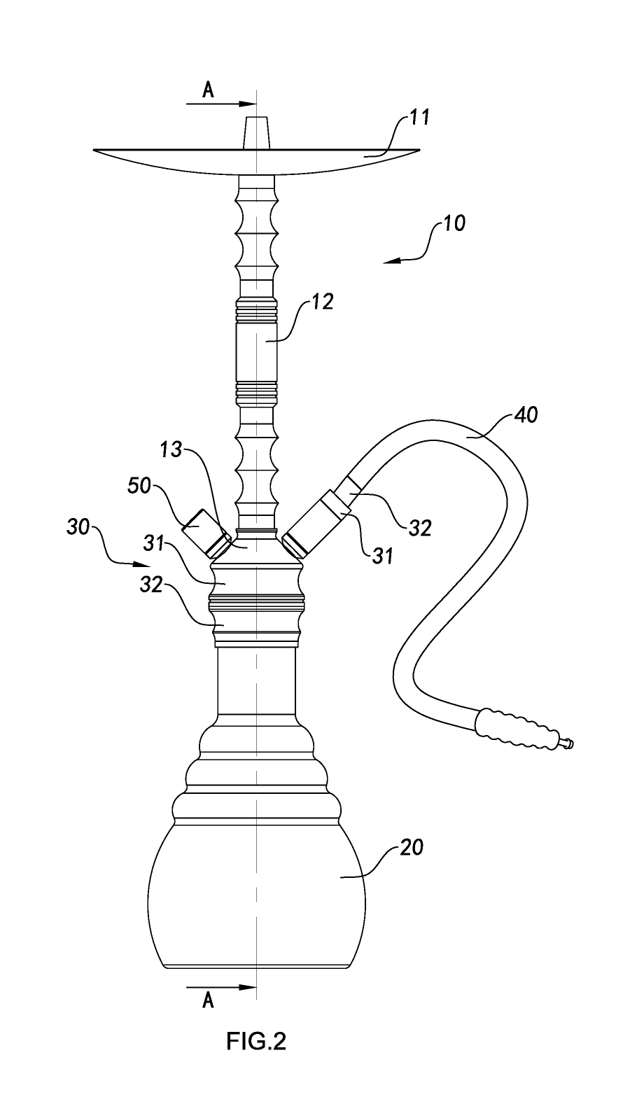

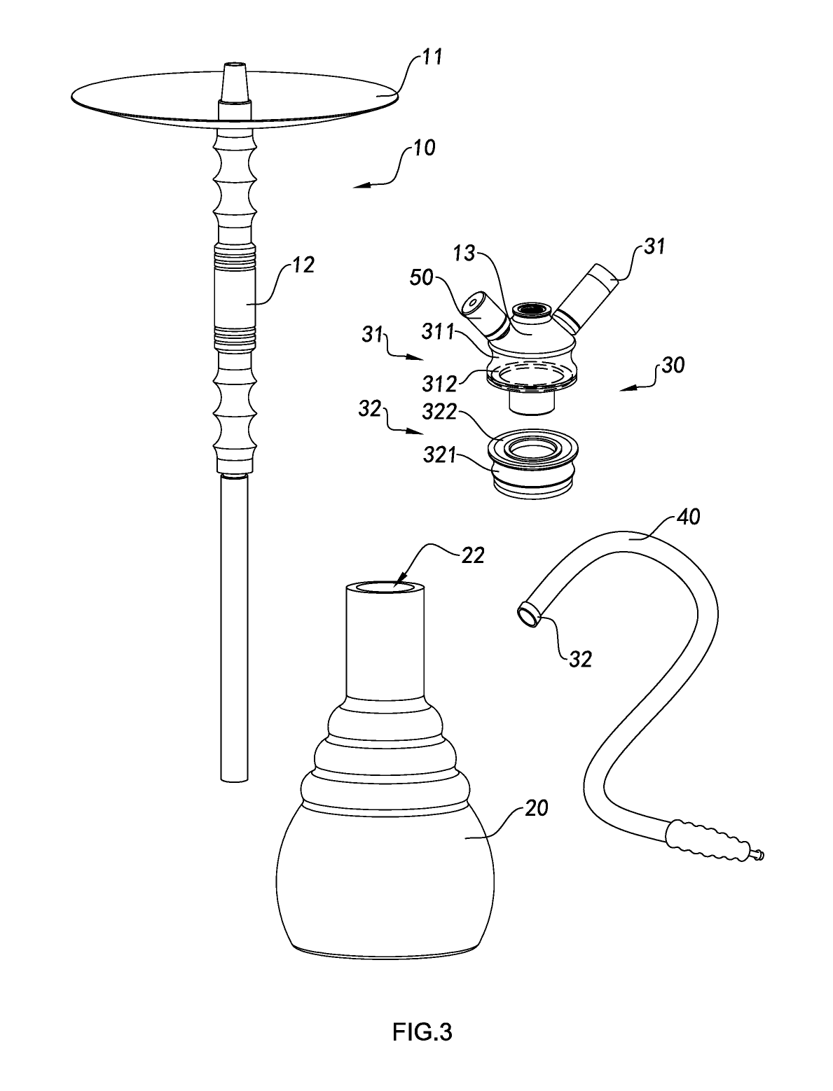

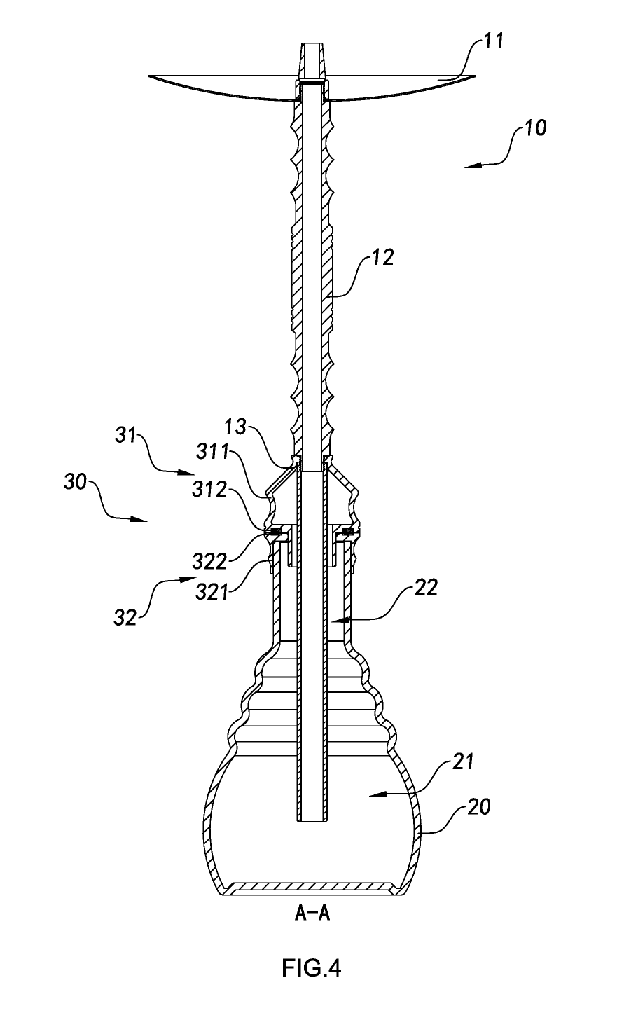

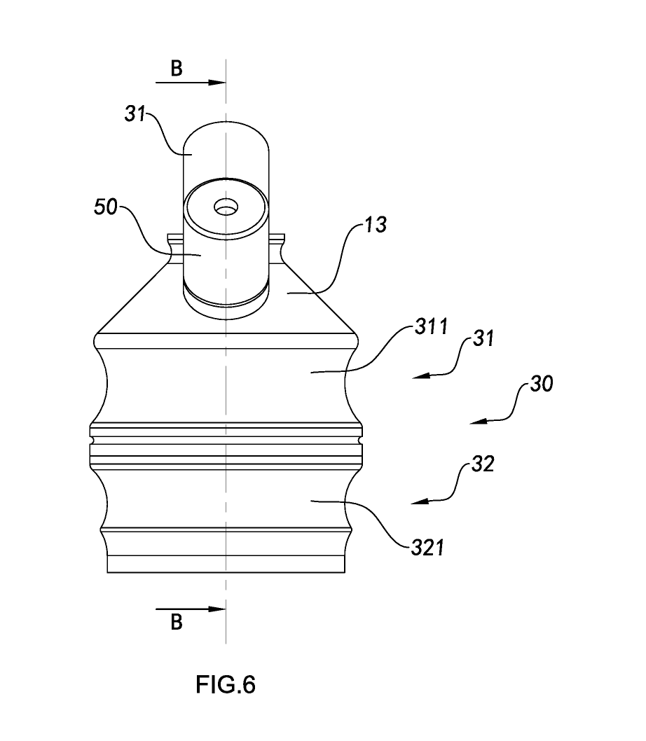

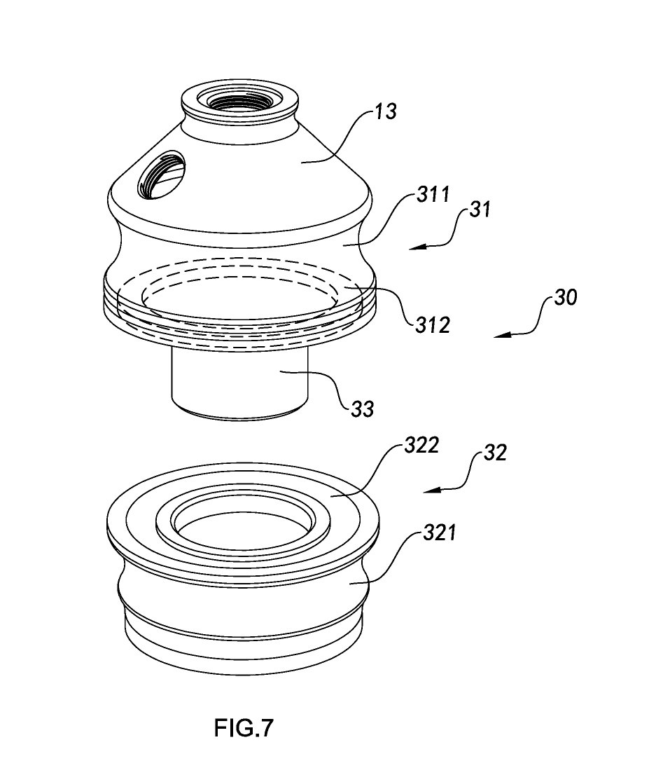

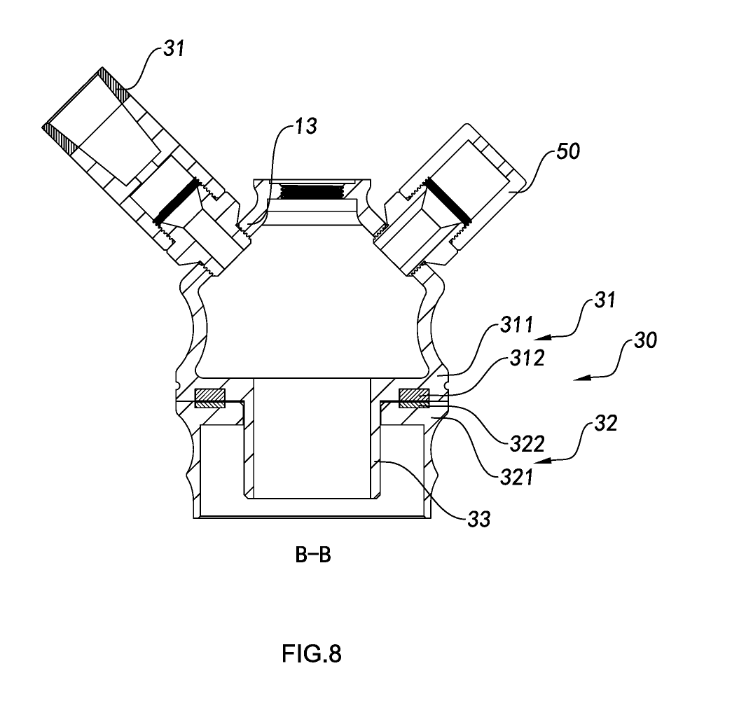

Referring to FIGS. 1 to 8, the hookah smoking device according to a first preferred embodiment of the present invention is illustrated, wherein the hookah smoking device comprises a loading unit 10, a filtering unit 20, and a connecting mechanism 30. The connecting mechanism is for detachably connecting the loading unit 10 and the filtering unit 20.

Further, the hookah smoking device comprises at least a smoking inhaler 40. Each smoking inhaler 40 is spacedly arranged on the loading unit 10, so that the smoker(s) may use the hookah smoking device with each smoking inhaler 40.

According to the preferred embodiment, the smoking inhaler 40 is integrally formed with the loading unit 10. In another preferred embodiment of the hookah smoking device according to the present invention, the smoking inhaler 40 is detachably connected with the loading unit 10. Preferably, the loading unit 10 and smoking inhaler 40 is detachably connected with each other via the connecting mechanism 30.

It is worth mentioning that the loading unit 10 and the smoking inhaler 40 of the hookah smoking device of the present invention can be connected by the connecting mechanism 30 in the appended drawings. The person skilled in the art should understand that the way of connecting the loading unit 10 and the smoking inhaler 40 disclosed in the appended drawings is only an example. That is to say, in another embodiment of hookah smoking device of the present invention, the loading unit 10 and the smoking inhaler 40 can also be detachably connected by different connecting structures. For instance, the loading unit 10 and the smoking inhaler 40 can be coupled with each other via a threaded structure.

Besides, the hookah smoking device further comprises one or more ventilating units 50, arranged on the loading unit 10. Correspondingly, the ventilating unit 50 can be integrally formed with the loading unit 10 or detachably mounted on the loading unit 10. For example, the connecting mechanism 30 is also arranged for detachably connecting the loading unit 10 and the smoking inhaler 40.

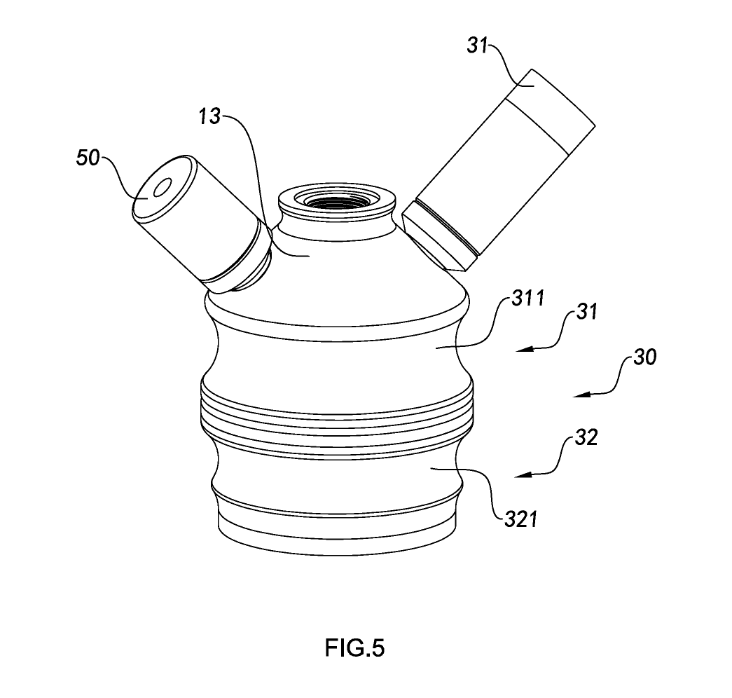

Referring to FIGS. 5 to 8, the connecting mechanism 30 further comprises a first connecting unit 31 and a second connecting unit 32. The first connecting unit 31 is arranged on the loading unit 10, while the second connecting unit 32 is arranged on the filtering unit 20. The first connecting unit 31 and the second connecting unit 32 are magnetic units to be detachably connected via magnetically attracting force, so that the loading unit 10 and the filtering unit 20 are detachably assembled and mounted on each other.

In other words, when the first connecting unit 31 and the second connecting unit 32 are placed closed to each other, they can interact to generate the magnetically attractive forces between each other, so that the first connecting unit 31 and the second connecting unit 32 can be coupled together. In this way, the connecting mechanism 30 is able to assemble the loading unit 10 and the first filtering unit 20 together.

The loading unit 10 comprises a loading body 11, a conveying channel 12 downwardly extended from the loading body 11, and an assembling body 13 coupled to the conveying channel 12. The conveying channel 12 is extended through the assembling body 13. The loading body 11 is arranged on the upper portion of the conveying channel 12. The first connecting unit 31 is arranged on the assembling body 13 or integrally formed with the assembling body 13. That is to say, in a preferred embodiment of the hookah smoking device according to the present invention, the first connecting unit 31 and the assembling body 13 are integrally formed and shaped. Nevertheless, in another preferred embodiment of the hookah smoking device according to the present invention, the first connecting unit 31 and the assembling body 13 are separately made. Then the first connecting unit 31 is arranged on the assembling body 13. It is worth mentioning that the ventilating unit 50 is radially and upwardly extended from the assembling body 13.

The filtering unit 20 comprises a filter chamber 21 and an opening 22 communicating with the filter chamber 21. The liquid, such as water, for filtering the harmful ingredients of the smoke generated by tobacco or its substitute, is added into the filter chamber 21 through the opening 22. The second connecting unit 32 is arranged at the position of the opening 22 of the filtering unit 20. The first connecting unit 31 is connected to the second connecting unit 32, so that the assembling body 13 of the loading unit 10 can be mounted on top of the filtering unit 20. At this moment, the lower portion of the conveying channel 12 is extended into and retained in the filter chamber 21 and can be kept under the liquid level of the liquid.

Correspondingly, the first connecting unit 31 is arranged on the assembling body 13 of the loading unit 10. The second connecting unit 32 is arranged at the connecting end of the smoking inhaler 40. The second connecting unit 32 can be connected to the first connecting unit 31, so that the smoking inhaler 40 can be mounted on the assembling body 13 of the loading unit 10.

It is worth mentioning that at least one of the first connecting unit 31 and the second connecting unit 32 is magnetic body or contains magnetic body, such that they can interact to generate the magnetically attractive forces between each other. Therefore, the first connecting unit 31 and the second connecting unit 32 can be connected to each other by magnetically attaching to each other.

For example, as an embodiment of the hookah smoking device according to the present invention, the first connecting unit 31 is a magnetically attracting connector that does not contains magnetic body, but is able to magnetically attract with a magnetic body.

For instance, the first connecting unit 31 can be made with iron. The second connecting unit 32 is a magnetic body or a connector that contains a magnetic body. When the first connecting unit 31 and the second connecting unit 32 are placed close to each other within a proper distance, they can interact to generate the magnetically attractive forces to each other therebetween, so that they can be magnetically connected together.

For another example, as another embodiment of the hookah smoking device according to the present invention, the first connecting unit 31 is magnetic body or a connector that contains a magnetic body. The second connecting unit 32 is a connector that does not contains magnetic body, but is able to magnetically attract with a magnetic body. When the first connecting unit 31 and the second connecting unit 32 are placed closed to each other within a proper distance, they can interact to generate the magnetically attractive forces to each other therebetween, so that they can be magnetically connected together.

For another example, as another embodiment of the hookah smoking device according to the present invention illustrated, the first connecting unit 31 and the second connecting unit 32 are both connectors that contain magnetic body. Specifically speaking, the first connecting unit 31 comprises a ring shaped first connecting body 311 and a magnetic first connecting element 312. The first magnetic connecting body 311 is arranged on the assembling body 13 or integrally formed with the assembling body 13. The first connecting element 312 is arranged on the first connecting body 311. Preferably, the first connecting element 312 is ring shaped for the first connecting element 312 to be arranged on the outside of the first connecting body 311 or for a plurality of the first connecting elements 312 to be circularly distributed on the outside of the first connecting body 311.

Correspondingly, the second connecting unit 32 comprises a ring shaped second connecting body 321 and a magnetic second connecting element 322. The second connecting body 321 is arranged at the position of the opening 22 of the filtering unit 20. The second connecting element 322 is arranged on the second connecting body 321. Preferably, the second connecting element 322 is ring shaped for the second connecting element 322 to be arranged on the outside of the second connecting body 321 or for a plurality of the second connecting element 322 to be circularly distributed on the outside of the second connecting body 321.

When assembling the loading unit 10 and the filtering unit 20, the first connecting body 311 is moved to a proper distance from the second connecting body 321, so that they can interact to generate the magnetically attractive forces between each other, so that the first connecting element 312 and the second connecting element 322 can be coupled together. In this way, the connecting mechanism 30 of the hookah smoking device according to the present invention can directly assemble the loading unit 10 and the filtering unit 20 together without applying the turning force of the prior art to assemble the loading unit 10 and the filtering unit 20.

Those skilled in the art should understand that the way that the hookah smoking device according to the present invention utilize the connecting mechanism 30 to directly assemble the loading unit 10 and the filtering unit 20 not only speeds up the changing the liquid in the filter chamber 21 of the filtering unit 20, but also avoids detaching the smoking inhaler 40 from the loading unit 10 during the processes of disassembling and assembling the loading unit 10 and the filtering unit 20. This unexpected result cannot be achieved by the prior art and is especially effective in enhancing the efficiency of the hookah smoking device.

It is worth mentioning that the first connecting element 312 and the second connecting element 322 have proper range of magnetism for generating attractive forces therebetween to assemble the loading unit 10 and filtering unit 20 together. Besides, when the hookah smoking device is being moved or used, the magnetically attractive forces generated between the first connecting element 312 and the second connecting element 322 can prevent the loading unit 10 and the filtering unit 20 from automatically separating from each other, which guarantees the reliability of the hookah smoking device when it is in use. For instance, the hookah smoking device is normally carried and moved by grasping the loading unit 10. At that moment, the gravity of the filtering unit 20 and the liquid contained in the filter chamber 21 of the filtering unit 20 will all act on the connecting mechanism 30. At this point, the strength of the mutually magnetically attractive force generated between the first connecting element 312 and the second connecting element 322 is greater than the gravity of the filtering unit 20 and the liquid contained in the filter chamber 21 of the filtering unit 20.

When the first connecting element 312 and the second connecting element 322 are coupled with each other to make the first connecting body 311 and the second connecting body 321 to be interlocked, the first connecting element 312 and the second connecting element 322 also prevent gap from being created between the first connecting body 311 and the second connecting body 321 for the convenience of the smoker in using the hookah smoking device.

Further, the first connecting body 311 and the second connecting body 321 have oxidation resistance layers thereon for preventing the first connecting body 311 and the second connecting body 321 from being oxidized due to humid environment. Those skilled in the art should understand that once either of the first connecting body 311 or the second connecting body 321 is oxidized, the contact surfaces between the first connecting body 311 and the second connecting body 321 will become rough and uneven due to the oxidation. Accordingly, through the connection between the first connecting element 312 and second connecting element 322, the first connecting body 311 and the second connecting body 321 are surface-engaged with each other. The gap between the contact surfaces of the first connecting body 311 and the second connecting body 321 will be one of the major factors to cause the leakage problem of the hookah smoking device. In addition, the magnetically attractive forces generated between the first connecting element 312 and the second connecting element 322 will also be significantly decreased due to the oxidation. Therefore, the hookah smoking device according to the present invention has the oxidation resistance layers respectively on the surfaces of the first connecting body 311 and the second connecting body 321, which enhances the engagement of the hookah smoking device and ensures the reliability of the use of the hookah smoking device. Especially, it guarantees the reliability of the hookah smoking device when it is moved by grasping the loading unit 10.

The connecting mechanism 30 further comprises a ring shaped aligning body 33 integrally and coaxially extended from the first connecting body 311 of the first connecting unit 31. When the first connecting element 312 and the second connecting element 322 attract and attach to each other for connecting the first connecting body 311 and the second connecting body 321, the aligning body 33 is coaxially inserted into and retained in the second connecting body 321. In this way, when the hookah smoking device is moving, the aligning body 33 can prevent horizontal dislocation from being created between the first connecting body 311 and the second connecting body 312. This ensures maximum attractive forces being generated between the first connecting element 312 and the second connecting element 322 when the loading unit 10 does not have to be disassembled from the filtering unit 20, which guarantee the reliability of the hookah smoking device. In other words, the aligning body 33 can restrict and prevent the assembled loading unit 10 and filtering unit 20 from having horizontal dislocation therebetween, so as to ensure the reliability of the hookah smoking device as it is being used and moved.

When using the hookah smoking device, the user is able to tilt at least one of the loading unit 10 and the filtering unit 20. At this moment, the surface to surface contacting engagement between the first connecting body 311 and the second connecting body 321 becomes a point to point contacting engagement. Therefore, the magnetically attractive forces generated between the magnetic first connecting element 312 and the magnetic second connecting element 322 will be substantially decreased, so as to allow the loading unit 10 to be easily detached from the filtering unit 20 for filling the liquid therein.

It is worth mentioning that the function of the aligning body 33 is to prevent the decreasing of the magnetically attractive forces generated between the magnetic first connecting element 312 and the magnetic second connecting element 322 caused by horizontal dislocation between the first connecting body 311 and the second connecting body 321 during the use of the hookah smoking device. Those skilled in the art should understand that when the loading unit 10 and the filtering unit 20 are demanded for being disassembled, the user, such as a smoker or a service personnel, can easily tilt the loading unit 10 and the filtering unit 20 without being limited by the aligning body 33. This way can not only prevent the hookah smoking device from misoperation when it is in use, but also enhance the operability of the hookah smoking device.

The liquid can be added into the filter chamber 21 with the opening 22 of the filtering unit 20. Besides, the liquid in the filter chamber 21 can be drained from the opening 22. The loading unit 10 is moved to a proper distance from the filtering unit 20. The proper distance can, for example, allow the first connecting body 311 that is arranged on the assembling body 13 or integrally formed with the assembling body 13 to stay on the upper portion of the second connecting body 321. Then, the magnetic first connecting element 312 and the magnetic second connecting element 322 are able to interact, such that there are magnetically attractive forces generated between the first connecting element 312 and the second connecting element 322 to create tendency and displacement for the first connecting body 31 to automatically move to the second connecting unit 32. Therefore, the first connecting body 311 and the second connecting body 321 can be connected together by having the contact surfaces of the second connecting body 321 and first connecting body 311 contact each other. Through this way, the connecting mechanism 30 can quickly and reliably assemble the loading unit 10 and the filtering unit 20 together.

That is to say, when the loading unit 10 is moved to a proper distance from the filtering unit 20, the magnetic first connecting element 312 and the magnetic second connecting element 322 will generate the magnetically attractive forces to each other therebetween, so that they can automatically attach, align, and couple to each other, which helps to connect the loading unit 10 and the filtering unit 20.

Those skilled in the art should understand that the way provided by the hookah smoking device according to the present invention to assemble the loading unit 10 with the filtering unit 20 can be completed by a user with one hand. For example, the user may put the filtering unit 20 on a table or workbench and then grasp the loading unit 10 with one hand to move the loading unit 10 to a proper position relative to the filtering unit 20, so that the first connecting element 312 and the second connecting element 322 can automatically connect for the assembling of the loading unit 10 and the filtering unit 20. This kind of method is unexpectable for the hookah pot according to prior art, but is especially effective for improving the operation and use of the hookah smoking device.

When tobacco or its substitute is placed at the loading unit 10, the smoker may suck the free end of the smoking inhaler 40 to reduce the pressure in the filter chamber 21 of the filtering unit 20. Then smoke generated from the tobacco or its substitute can enter the filter chamber 21 of the filtering unit 20 through the conveying channel 12. When the smoke is rising in the liquid contained in the filter chamber 21, harmful substances contained in the smoke will be filtered by the liquid. Subsequently, the smoke will rise into the space that does not contain the liquid in the filter chamber 21 and then be smoked by the smoker. It is worth mentioning that the character of the liquid will determine which harmful ingredient in the smoke generated by the tobacco or its substitute the liquid is able to filter.

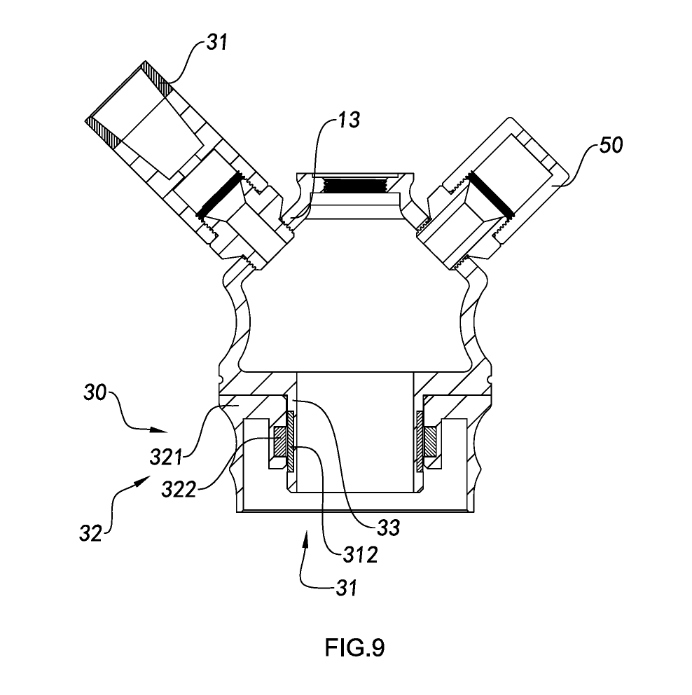

FIG. 9 illustrates an alternative of the hookah smoking device according the above preferred embodiment of the present invention. Specifically speaking, the first connecting element 312 is arranged on the aligning body 33. When the aligning body 33 is inserted into the second connecting body 321, the magnetic first connecting element 312 and the magnetic second connecting element 322 can interact, so as to generate magnetically attractive forces therebetween. In this way, the connecting mechanism 30 can mount and assemble the loading unit 10 on the filtering unit 20.

It is worth mentioning that, in an embodiment of the hookah smoking device according to the present invention, the first connecting unit 31 can only comprise one first connecting element 312. In other words, the aligning body 33 can be integrally extended from the assembling body 13 of the loading unit 10, while the first connecting element 312 is arranged on the aligning body 33. When the aligning body 33 is inserted into the second connecting body 321, the magnetic first connecting element 312 and the magnetic second connecting element 322 can interact, so as to generate magnetically attractive forces therebetween. In this way, the connecting mechanism 30 can mount and assemble the loading unit 10 on the filtering unit 20.

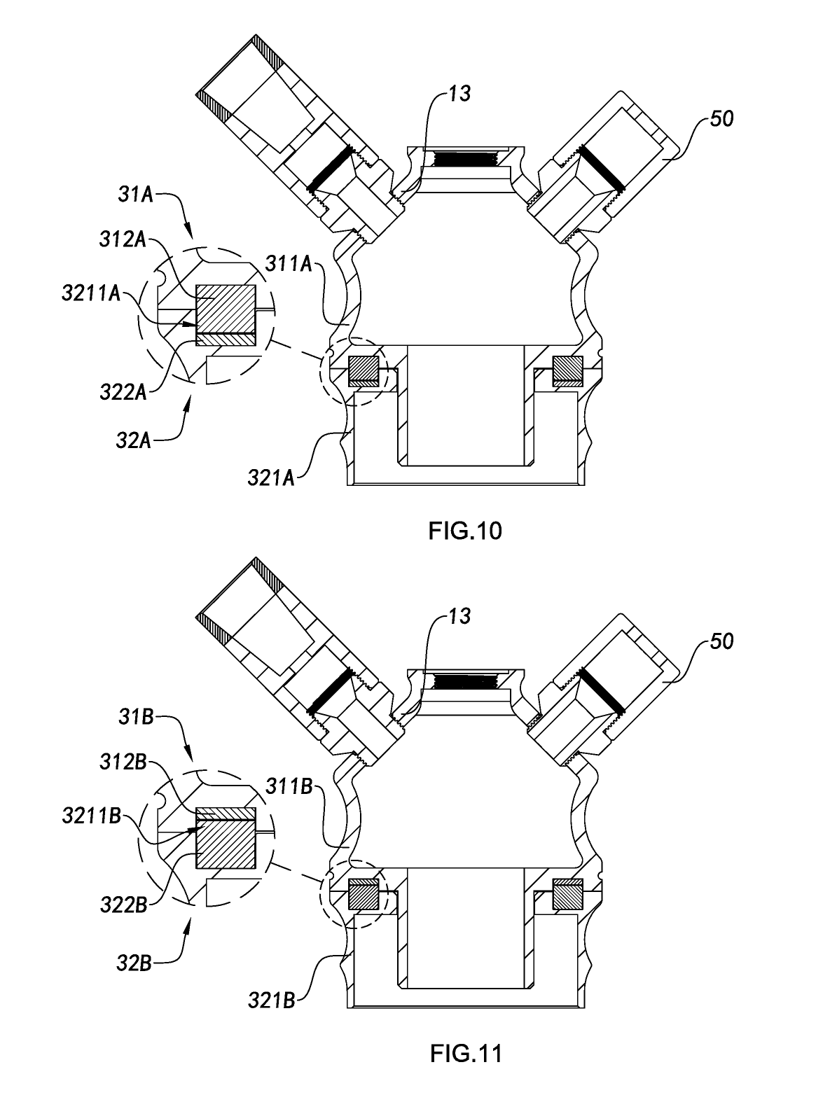

FIG. 10 illustrates another alternative of the hookah smoking device according to the above preferred embodiment provided by the present invention. Specifically speaking, the connecting mechanism 30 comprises a magnetic first connecting unit 31A and a magnetic second connecting unit 32A. The first connecting unit 31A is arranged on the assembling body 13 of the loading unit 10 or the first connecting unit 31A and the assembling body 13 of the loading unit 10 are integrally formed and shaped. Besides, the second connecting unit 32A is arranged on the filtering unit 20. When the first connecting unit 31A and the second connecting unit 32A approach each other to generate mutually magnetically attractive force between each other, the connecting mechanism 30 is able to assemble the loading unit 10 and the filtering unit 20 together.

Further, the first connecting unit 31A comprises a first connecting body 311A and a magnetic first connecting element 312A. The first connecting body 311A is arranged on the assembling body 13 or integrally formed with the assembling body 13. The first connecting element 312A is protruded from the first connecting body 311A. Correspondingly, the second connecting unit 32A comprises a second connecting body 321A and a magnetic second connecting element 322A. The second connecting body 321A is arranged on the filtering unit 20 or integrally formed with the entire or part of the filtering unit 20. The second connecting element 322A is arranged on the second connecting body 321A.

In the present embodiment of the hookah smoking device according to the present invention illustrated in FIG. 10, the second connecting body 321A comprises an aligning groove 3211A thereon, while the second connecting element 322A is arranged in the aligning groove 3211A of the second connecting body 321A, wherein a thickness of the second connecting element 322A is smaller a depth of the aligning groove 3211A, such that when the first connecting element 312A and the second connecting element 322A are magnetically engaged with each other, the first connecting element 312A is also inserted into the aligning groove 3211A. Nonetheless, those skilled in the art should understand that in another embodiment of the hookah smoking device according to the present invention, the second connecting element 322A that is arranged on the second connecting body 321A can also form the aligning groove 3211A.

When the first connecting unit 31A is moved to a proper position relative to the second connecting unit 32A, the first connecting element 312A and the second connecting element 322A will be able to interact, so as to generate the magnetically attractive forces between each other. Therefore, the first connecting element 312A can automatically align with the aligning groove 3211 and connect to the second connecting element 322A. In this way, the connecting mechanism 30 not only assembles the loading unit 10 and the filtering unit 20 together, but also restricts and prevents horizontal dislocation between the loading unit 10 and the filtering unit 20 by means of having the first connecting element 312A to align with the aligning groove 3211A and to be connected to the second connecting element 322A. Hence, it can ensure that when the hookah smoking device is being moved or used, the loading unit 10 and the filtering unit 20 will not automatically separated from each other due to misoperation thereon.

FIG. 11 illustrates another alternative of the hookah smoking device according to the above preferred embodiment provided by the present invention. Specifically speaking, the connecting mechanism 30 comprises a magnetic first connecting unit 31B and a magnetic second connecting unit 32B. The first connecting unit 31B is arranged on the assembling body 13 of the loading unit 10 or the first connecting unit 31B and the assembling body 13 of the loading unit 10 are integrally formed and shaped. Besides, the second connecting unit 32B is arranged on the filtering unit 20. When the first connecting unit 31B and the second connecting unit 32B approach each other to generate mutually attractive force between each other, the connecting mechanism 30 is able to assemble the loading unit 10 and the filtering unit 20 together.

Further, the first connecting unit 31B comprises a first connecting body 311B and a magnetic first connecting element 312B. The first connecting body 311B is arranged on the assembling body 13 or integrally formed with the assembling body 13. The first connecting element 312B is arranged on the first connecting body 311. Correspondingly, the second connecting unit 32B comprises a second connecting body 321B and a magnetic second connecting element 322B. The second connecting body 321B is arranged on the filtering unit 20 or integrally formed with the entire or part of the filtering unit 20. The second connecting element 322B is protruded from the second connecting body 321B.

In the present embodiment of the hookah smoking device according to the present invention illustrated in FIG. 11, the first connecting body 311B comprises an aligning groove 3211B thereon, while the first connecting element 312B is arranged in the aligning groove 3211B of the first connecting body 311B. A thickness of the first connecting element 312B is smaller than a depth of the aligning groove 3211B, wherein when the first connecting element 312B and the second connecting element 322B are magnetically engaged with each other, the second connecting element 322B is inserted into the aligning groove 3221B. Nonetheless, those skilled in the art should understand that in another embodiment of the hookah smoking device according to the present invention, the first connecting element 312B that is arranged on the first connecting body 3211B can also form the aligning groove 3211B.

When the first connecting unit 31B is moved to a proper position relative to the second connecting unit 32B, the first connecting element 312B and the second connecting element 322B will be able to interact, so as to generate the magnetically attractive forces between each other. Therefore, the first connecting element 312B can automatically align with the aligning groove 3211B and connect to the second connecting element 322B. In this way, the connecting mechanism 30 not only assembles the loading unit 10 and the filtering unit 20 together, but also restrict and prevent horizontal dislocation between the loading unit 10 and the filtering unit 20 by means of having the second connecting element 322B to align with the aligning groove 3211B and to be connected to the first connecting element 312B. Hence, it can ensure that when the hookah smoking device is being moved or used, the loading unit 10 and the filtering unit 20 will not automatically separated from each other due to misoperation thereon.

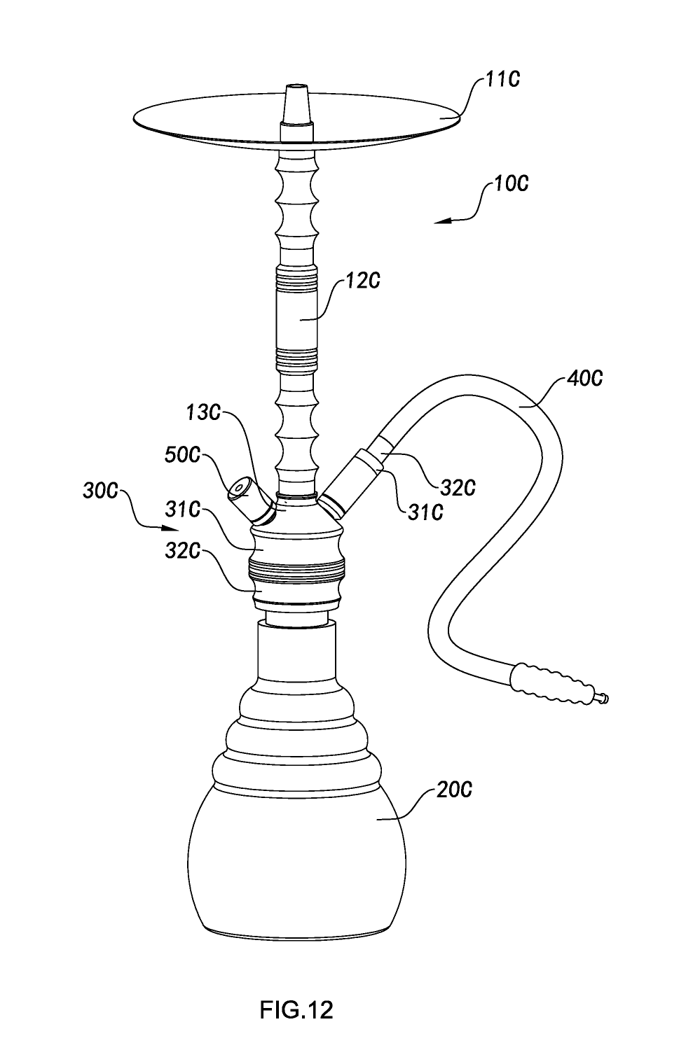

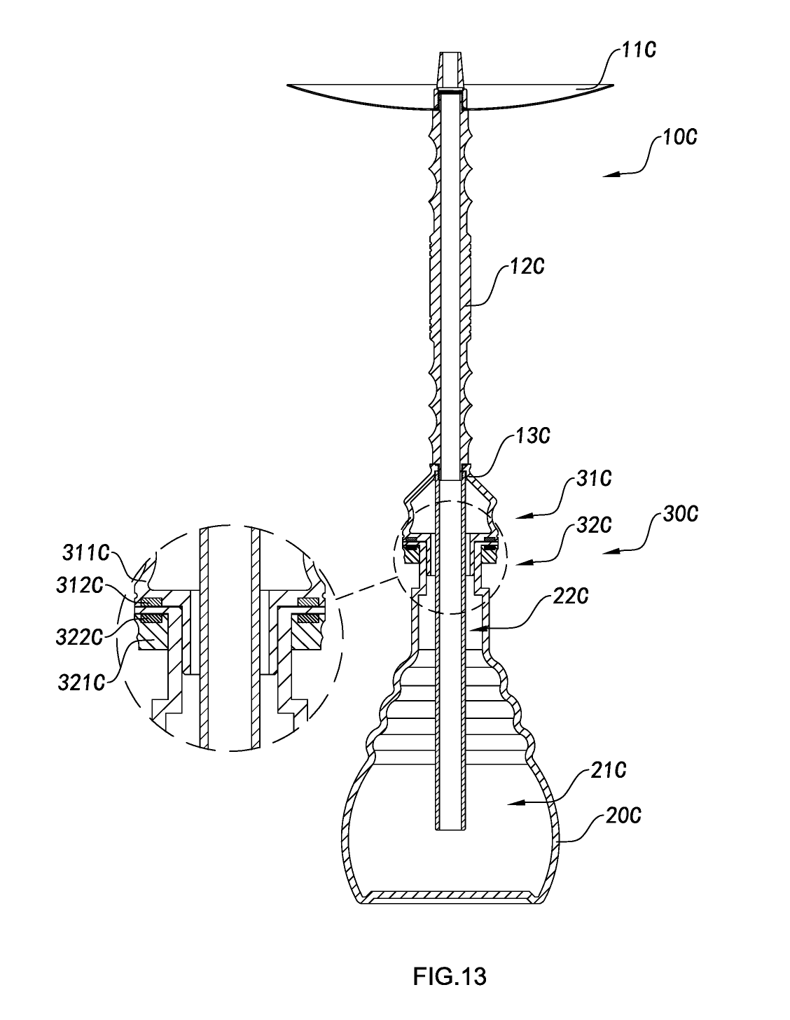

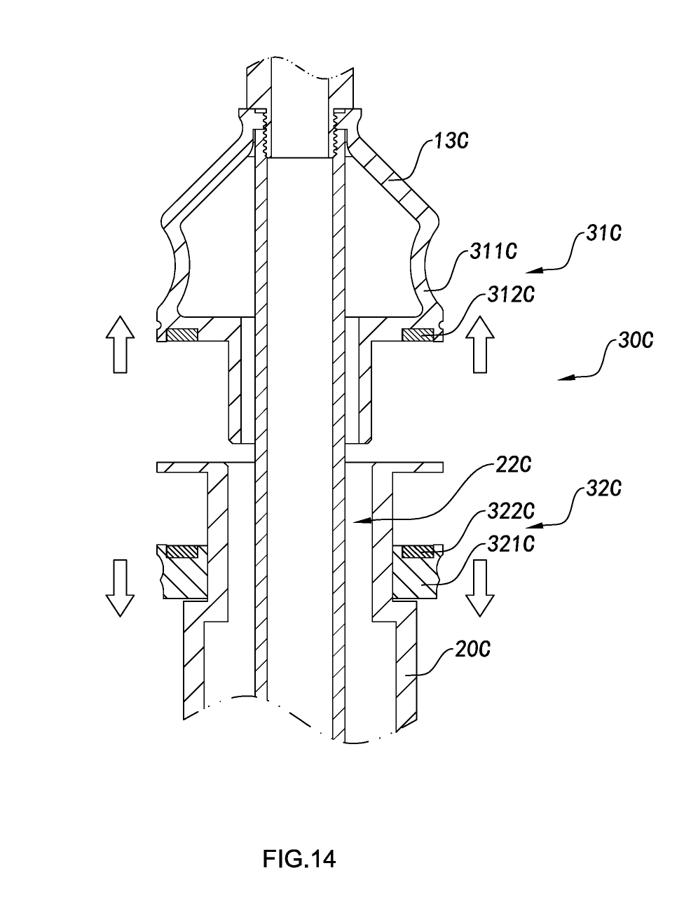

Referring to FIGS. 12 to 14, the hookah smoking device according to a second preferred embodiment of the present invention is illustrated, wherein the hookah smoking device comprises a loading unit 10C, a filtering unit 20C, and a connecting mechanism 30C. The connecting mechanism 30C is for detachably connecting the loading unit 10C and the filtering unit 20C.

Further, the hookah smoking device comprises at least a smoking inhaler 40C. Each smoking inhaler 40C is spacedly arranged on the loading unit 10C, so that the smoker(s) may use the hookah smoking device with each smoking inhaler 40C. Preferably, the connecting mechanism 30C is able to detachably mount the smoking inhaler 40C on the loading unit 10C, so as to allow the hookah smoking device to be used.

Further, the hookah smoking device comprises a ventilating unit 50C, arranged on the loading unit 10C. Preferably, the connecting mechanism 30C is able to detachably mount the ventilating unit 50C on the loading unit 10C, so as to allow the hookah smoking device to be used, including to make the cleaning of the ventilating unit 50C easier.

The connecting mechanism 30C further comprises a magnetic first connecting unit 31C and a magnetic second connecting unit 32C. The first connecting unit 31C is arranged on the loading unit 10C, while the second connecting unit 32C is arranged on the filtering unit 20C. The first connecting unit 31C and the second connecting unit 32C are detachably connected by attaching to each other, so that the loading unit 10C and the filtering unit 20C are detachably assembled and mounted on each other.

In a preferred embodiment of the hookah smoking device according to the present invention, the first connecting unit 31C is arranged on the loading unit 10C or has a part thereof integrally formed with part of the loading unit 10C. The second connecting unit 32C is movably arranged on the filtering unit 20C, so as to allow separation of the second connecting unit 32C and the first connecting unit 31C for separating and disassembling the loading unit 10C from the filtering unit 20C through changing the position of the second connecting unit 32C relative to the first connecting unit 31C.

In another preferred embodiment of the hookah smoking device according to the present invention, the first connecting unit 31C is arranged on the loading unit 10C. The second connecting unit 32C is arranged on the filtering unit 20C, so as to allow the separation of the first connecting unit 31C and the second connecting unit 32C for disassembling the loading unit 10C from the filtering unit 20C through changing the position of the first connecting unit 31C relative to the residence of the second connecting unit 32C.

Those skilled in the art should understand that, in another preferred embodiment of the hookah smoking device according to the present invention, the first connecting unit 31C is detachably coupled at the loading unit 10C via a threaded structure, while the second connecting unit 32C is movably and coaxially coupled at a neck portion of the filtering unit 20C, so that when an operating personnel, such as a smoker or a service staff, is operating the hookah smoking device, he or she can selectively operate at least one of the first connecting unit 31C and the second connecting unit 32C to separate the loading unit 10C and the filtering unit 20C.

Although there are many different ways of connection between the first connecting unit 31C of the connecting mechanism 30C of the hookah smoking device of the present invention and the loading unit 10C and between the second connecting unit 32C and the filtering unit 20C, however, in order for better description, the appended drawings of the specification of the present invention only demonstrates the embodiment of the first connecting unit 31C being arranged on the loading unit 10C and the second connecting unit 32C being movably arranged on the filtering unit 20C.

The loading unit 10C comprises a loading body 11C, a conveying channel 12C, and an assembling body 13C, wherein the assembling body 13C and the loading body 11C are respectively arranged on the conveying channel 12C. Preferably, the loading body 11C is arranged on the upper portion of the conveying channel 12C, while the assembling body 13C is arranged on the middle portion of the conveying channel 12C. The first connecting unit 31C is arranged on the assembling body 13C or integrally formed with the assembling body 13C.

The filtering unit 20C comprises a filter chamber 21C and an opening 22C communicating with the filter chamber 21C. The liquid, such as water, for filtering the harmful ingredients of the smoke generated by tobacco or its substitute, is added into the filter chamber 21C through the opening 22C. The second connecting unit 32C is actionably arranged at the position of the opening 22C of the filtering unit 20C. The first connecting unit 31C can be connected to the second connecting unit 32C, so that the assembling body 13C of the loading unit 10C can be mounted on the filtering unit 20C. At this moment, the lower portion of the conveying channel 12C is inserted into and retained in the filter chamber 21C and immersed below the liquid level of the liquid.

Correspondingly, the first connecting unit 31C is arranged on the assembling body 13C of the loading unit 10C. The second connecting unit 32C is detachably coupled at the connecting end of the smoking inhaler 40C. The second connecting unit 32C can be connected to the first connecting unit 31C, so that the smoking inhaler 40C can be mounted on the assembling body 13C of the loading unit 10C.

It is worth mentioning that at least one of the first connecting unit 31C and the second connecting unit 32C is magnetic body or contains magnetic body, such that they can be connected to each other by magnetically attracting and attaching to each other. Preferably, the first connecting unit 31C and the second connecting unit 32C both contain magnetic body.

Specifically speaking, the first connecting unit 31C comprises a tubular shaped first connecting body 311C and a first connecting element 312C. The first connecting body 311C is arranged on the assembling body 13C or integrally formed with the assembling body 13C. The first connecting element 312C is arranged on the first connecting body 311C. Preferably, in a preferred embodiment of the hookah smoking device, the first connecting element 312C is ring shaped, so that the first connecting element 312C can be arranged on the outside of the first connecting body 311C. In another preferred embodiment of the hookah smoking device, a plurality of the first connecting element 312C can be circularly distributed on the outside of the first connecting body 311C.

The second connecting unit 32C comprises a ring shaped second connecting body 321C and a second connecting element 322C. The second connecting body 321C is movably arranged on the filtering unit 20C. The second connecting element 322C is arranged on the second connecting body 321C. Preferably, in a preferred embodiment of the hookah smoking device, the second connecting element 322C is ring shaped, so that the second connecting element 322C can be arranged on the outer surface of the second connecting body 321C. Accordingly, the second connecting unit 32C is movably and coaxially coupled at the neck portion of the filtering unit 20C, such that the second connecting body 321C is moved upwardly along the neck portion of the filtering unit 20C to magnetically engage the second connecting element 322C with the first connecting element 312C. In other words, the second connecting element 322C is movable and the first connecting element 312C is stationary. In another preferred embodiment of the hookah smoking device, a plurality of the second connecting element 322C can be circularly and radially distributed on the outer surface of the second connecting body 321C.

When using the hookah smoking device, an external force is applied on the second connecting body 321C to move the second connecting body in order to shift the second connecting element away the first connecting element 312C. At this moment, the magnetically attractive forces generated between the magnetic first connecting element 312C and the magnetic second connecting element 322C will be substantially decreased. As the distance between the first connecting element 312C and the second connecting element 322C becomes longer, the magnetically attractive forces generated therebetween and thereby will become smaller, such that the operating personnel can easily detached the loading unit 10C from the filtering unit 20C.

The liquid can be added into the filter chamber 21C with the opening 22C of the filtering unit 20C. Besides, the liquid in the filter chamber 21C can be drained from the opening 22C. The loading unit 10C is moved to a proper distance from the filtering unit 20C. The proper distance can, for example, allow the first connecting body 311C that is arranged on the assembling body 13C or integrally formed with the assembling body 13C to stay on the upper portion of the second connecting body 321C. Then the magnetic first connecting element 312C and the magnetic second connecting element 322C are able to interact, such that there are magnetically attractive forces generated between the first connecting element 312C and the second connecting element 322C to create tendency and displacement for the second connecting body 321C to automatically move to the first connecting body 311C. Therefore, the first connecting body 311C and the second connecting body 321C can be connected together by having the contact surfaces of the second connecting body 321C and the first connecting body 311C contact each other. Through this way, the connecting mechanism 30C can quickly and reliably assemble the loading unit 10C and the filtering unit 20C together.

Those skilled in the art should understand that the embodiments of the present invention illustrated in the above description and the appended drawings are only to give examples rather than limit the present invention. The objects of the present invention have completely and effectively achieved. The functions and structural principles of the present invention have been illustrated and described in the embodiments. The implementation of the present invention can also include whatever alternatives or modification without departing from these principles.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A hookah smoking device, comprising:
a loading unit;
a filtering unit; and
a connecting mechanism, which comprises at least one first connecting unit provided at said loading unit and at least one second connecting unit provided at said filtering unit, wherein said first connecting unit and said second connecting unit are magnetically coupled with each other to detachably couple said loading unit at said filtering unit.

2. The hookah smoking device, as recited in claim 1, further comprising at least a smoking inhaler extended from said loading unit.

3. The hookah smoking device, as recited in claim 2, wherein said smoking inhaler is detachably mounted on said loading unit.

4. The hookah smoking device, as recited in claim 3, wherein said smoking inhaler is detachably mounted on said loading unit via said connecting mechanism that said first connecting unit is also provided at said loading unit and said second connecting unit is also provided at said smoking inhaler, such that said first connecting unit and said second connecting unit are magnetically coupled with each other to detachably couple said smoking inhaler at said filtering unit.

5. The hookah smoking device, as recited in claim 1, further comprising a ventilating unit coupled on said loading unit.

6. The hookah smoking device, as recited in claim 4, further comprising a ventilating unit coupled on said loading unit.

7. The hookah smoking device, as recited in claim 1, wherein said loading unit comprises an assembling body that said first connecting unit is provided thereat, a conveying channel extended through said assembling body, and a loading body provided at upper portion of said conveying channel, wherein said filtering unit comprises a filter chamber and an opening communicated with said filter chamber, wherein said second connecting unit is provided at said opening of said filtering unit, such that when said first connecting unit and said second connecting unit are magnetically coupled with each other, said assembling body is coupled at said opening of said filtering unit at a position that a lower portion of said conveying channel is inserted into said filter chamber.

8. The hookah smoking device, as recited in claim 7, wherein said first connecting unit comprises a first connecting body provided at said assembling body and a first connecting element received at said first connecting body, wherein said second connecting unit comprises a second connecting body provided at said opening of said filtering unit and a second connecting element received at said second connecting body, wherein said first connecting element and said second connecting element are magnetically engaged with each other to couple said first connecting body and said second connecting body in a surface-engaging manner.

9. The hookah smoking device, as recited in claim 8, wherein each of said first connecting body and said second connecting body has an oxidation resistance layer provided thereon.

10. The hookah smoking device, as recited in claim 8, wherein said first connecting element is protruded from said first connecting body, wherein said second connecting body has an aligning groove that said second connecting element is disposed in said aligning groove, wherein said first connecting element not only magnetically couples with said second connecting element but also engages with said aligning groove.

11. The hookah smoking device, as recited in claim 9, wherein said first connecting element is protruded from said first connecting body, wherein said second connecting body has an aligning groove that said second connecting element is disposed in said aligning groove, wherein said first connecting element not only magnetically couples with said second connecting element but also engages with said aligning groove.

12. The hookah smoking device, as recited in claim 10, wherein a thickness of second connecting element is smaller than a depth of said aligning groove.

13. The hookah smoking device, as recited in claim 11, wherein a thickness of second connecting element is smaller than a depth of said aligning groove.

14. The hookah smoking device, as recited in claim 8, wherein said first connecting body comprises an aligning groove that said first connecting element is disposed in said aligning groove, wherein said second connecting element is protruded from said second connecting body, wherein said second connecting element not only magnetically couples with said first connecting element but also engages with said aligning groove.

15. The hookah smoking device, as recited in claim 9, wherein said first connecting body comprises an aligning groove that said first connecting element is disposed in said aligning groove, wherein said second connecting element is protruded from said second connecting body, wherein said second connecting element not only magnetically couples with said first connecting element but also engages with said aligning groove.

16. The hookah smoking device, as recited in claim 14, wherein a thickness of first connecting element is smaller than a depth of said aligning groove.

17. The hookah smoking device, as recited in claim 15, wherein a thickness of first connecting element is smaller than a depth of said aligning groove.

18. The hookah smoking device, as recited in claim 8, wherein said connecting mechanism further comprises an aligning body integrally and coaxially extended from said first connecting body to insert into said second connecting body.

19. The hookah smoking device, as recited in claim 18, wherein said first connecting body is formed at said aligning body that said first connecting element is provided said aligning body, such that when said aligning body is inserted into said second connecting body, said first connecting element and said second connecting element are magnetically engaged with each other.

20. The hookah smoking device, as recited in claim 8, wherein said second connecting body is movably and coaxially coupled at a neck portion of said filtering unit, such that said second connecting body is moved upwardly to magnetically engage said second connecting element with said first connecting element.
